(19) United States
(12) Patent Application Publication
(10) Pub. No.: US 2006/0062876 A1
(43) Pub. Date: Mar. 23, 2006

(54) Method and device for opening a flexible pouch

(76) Inventor: Yvon Van Neste, Taro (IT)

Correspondence Address: ARENT FOX PLLC, 1050 CONNECTICUT AVENUE, N.W., SUITE 400, WASHINGTON, DC, 20036, US

(21) Appl. No.: 10/539,819

(22) PCT Filed: Feb. 10, 2003
(86) PCT No.: PCT/IT03/00062

§ 371 Date: Jun. 20, 2005

(30) Foreign Application Priority Data
Dec. 20, 2002 (IT) PR2002A000078

(51) Int. Cl. A23B 7/148

(52) U.S. Cl. 426/106; 426/113

(57) ABSTRACT

A method for opening a flexible pouch (1), and in particular heat-sensitive edges (3) of a mouth of the pouch, provides for the opening of the edges (3) of the mouth to occur by simple heating until the mutual detachment of the edges (3) of the opening with the formation of an adequate (6). A device for opening the pouch (1) comprises heating means so shaped as to heat a heat-sensitive area of the mouth of the pouch until causing its opening. The heating means can comprise at least a nozzle (7) able to emit a jet of warm air that heats the mouth of the pouch (1) or a pair of heated shaped guides (4) between which transits the area of the mouth of the of the pouch (1) whilst the guides (4) press against the pouch itself or are simply in contact therewith.

### TECHNICAL FIELD AND BACKGROUND ART

The present invention relates to a method and a device for opening a flexible pouch, preferably made of a multilayer film of polyethylene/aluminium/polyethylene or polyethylene/polyethylene with different molecular weight, and normally destined to contain liquid food products such as juices and drinks.

The pouch is provided with a mouth/stopper made of rigid plastic material, called spout, which must be applied to the pouch and sealed thereto, for instance by means of heat sealing or ultrasound sealing or high frequency sealing.

Said mouth or spout is used when filling the pouch with the food product, because usually then the user consumes the product through a straw that is inserted into the pouch by penetrating an appropriate membrane or weakened area of the pouch itself.

Currently, to open the pouch and introduce the spout therein, quite complex machines exist which perform complex motions.

Pincers are used with suction cups that slightly open the upper edges of the pouch while holding the pouch; a tube is then introduced, the pouch is closed around the tube, air is blown into the pouch until it is sufficiently inflated, and lastly the spout is introduced and sealed to the pouch.

One of the most critical and complex steps in the aforesaid method is the initial one of opening the mouth of the pouch, whose edges are mutually attached without any cleft.

### DISCLOSURE OF INVENTION

The aim of the present invention is to eliminate the aforesaid drawbacks, making available a method and a device that allow easily and rapidly to open the pouch within the context of an economical embodiment.

Said aims are fully achieved by the method and by the device of the present invention, which are characterised by the contents of the claims set out below.

In particular, the method provides for the opening of the edges of the spout of the pouch to take place by simple heating, and the heating step preferably lasts until the edges are detached and an adequate cleft is formed.

The device comprises heating means so conformed as to heat a heat-sensitive area of the mouth of the pouch until causing its opening.

The heating means can comprise at least a nozzle emitter of a jet of hot air which heats the mouth of the pouch until causing the detachment of the edges of the mouth, or they can comprise a pair of heated shaped guides between which transits the are of the mouth of the pouch whilst the guides press against the pouch itself or are simply in contact therewith.

### BEST MODE FOR CARRYING OUT THE INVENTION

This and other characteristics shall become more readily apparent from the following description of a preferred embodiment illustrated, purely by way of non limiting example, in the accompanying drawing tables, in which:

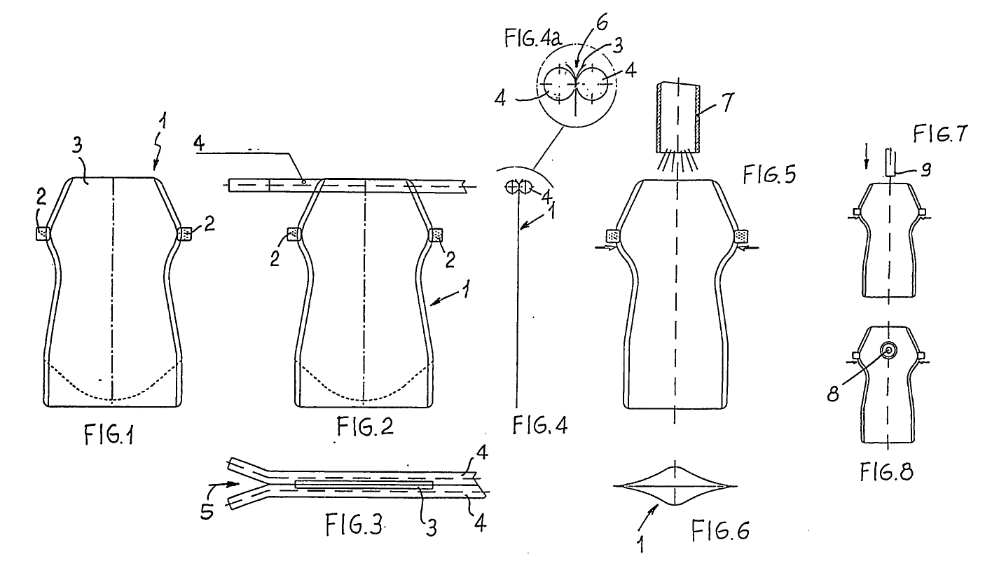

FIG. 1 shows a front view of the pouch;

FIGS. 2, 3, 4 and 4a respectively show a front view, a plan view and a lateral view and an enlargement of the pouch during the edge heating step;

FIGS. 5 and 6 respectively show a front and a plan view of the pouch in a step that can be the edge heating step according to an embodiment variation or can be a subsequent step to the one illustrated in FIG. 2;

FIGS. 7 and 8 show two subsequent steps of the method.

With reference to the figures, the number 1 globally indicates a flexible pouch, in particular for liquid food product, which is made of heat-sensitive material.

In the specific case the superposed sheets, preventively joined on three sides of the pouch are multilayer sheets of the polyethylene-aluminium-polyethylene type or of the type constituted by two layers of polyethylene with different molecular weight.

In particular, the inner layer of each sheet has a lower melting point than that of the outer layer and the thermal expansion coefficients of the inner and of the outer layer are different. The reason for this shall be clarified in the course of the description.

The pouch, whose upper edges 3 in the mouth area are substantially attached to each other without any cleft, is held in known fashion by pliers schematically indicated as 2.

To detach the edges 3 and to create an adequate cleft that allows the preliminary inflation of the pouch before the step of filling with the product, originally heating means are applied constituted by a pair of shaped guides 4 between which transits the pouch supported by the pliers, in the direction indicated by an arrow 5.

The guides 4 preferably have the shape of two cylindrical bars with circular cross section and are kept heated by appropriate means (for instance electrical resistors or internal circulation of steam) not show herein at a temperature of about 100° C.

The fact that the sheets constituting the pouch are of the multilayer type with the inner layer having a different thermal expansion coefficient from that of the layer constituting the exterior of the pouch, produces a separation of the edges 3 as a result of the heating operated by the guides 4, creating a cleft 6.

In a subsequent step, illustrated in FIGS. 5 and 6, through said cleft is blown air that produces the inflation of the pouch (shown in FIG. 6). The air, which preferably is sterile, is introduced through a nozzle 7 that blows coaxially on the pouch from above, but it can also be introduced through multiple nozzles blowing in different directions.

The Applicant has also surprisingly discovered that if warm air is used to inflate the pouch, and in particular air at the temperature of about 50° C., said flow of air is in itself sufficient both to detach the edges of the mouth and to achieve the subsequent inflation of the pouch and therefore, according to this, even simpler, embodiment variation, the heating of the mouth with the guides can be eliminated.

Once the edges 3 are separated, the mouth of the pouch must be fully open: to do so, one or more jets of sterile air can be used (as shown in FIG. 5), or a blade 9 or stainless steel element can be employed, which partially penetrates into the pouch as shown in FIG. 7, or one can be aided by suction cups that are attached to the lateral walls of the pouch, distancing them.

Thereafter, the pouch is inflated with sterile air, receives the spout in known fashion and the edges of the mouth are sealed to each other and around the spout. The fact that the melting point of the inner material is lower than that of the outer material allows to heat seal the parts that face internally to the pouch, preventing the outer parts from melting and becoming attached for example to the sealing bars or pliers.

Once the spout is readied, the pouch is filled according to a known technique.

The pouch can comprise a weakened area or a membrane 8 through which the user can introduce a straw to consume the content of the pouch.

In the specific case, the method and the device have been described for the opening of a flexible pouch provided with filling spout and destined to contain drinks, but they can be applied, without departing from the scope of protection of the invention, also to other types of pouches, with or without spout, destined to contain other types of products, in liquid, solid or powdered form.

In fact, neither the shape of the pouch nor the product it is to contain are essential, but only the material whereof the pouch is made, which must be such that the edges of the mouth of the pouch react positively to a heat source by widening and distancing from each other, forming a cleft.

1. Method for opening a flexible pouch (1), and in particular heat-sensitive edges (3) of a mouth of the pouch, characterised in that it the opening of the edges (3) of the mouth occurs by simple heating.

2. Method as claimed in claim 1, wherein the heating step lasts until the mutual detachment of the edges (3) of the opening with the formation of an adequate cleft (6).

3. Method as claimed in claim 1, wherein the heating is achieved by blowing warm air at a temperature of about 50° C.

4. Device for opening a flexible pouch (1), characterised in that it comprises heating means so shaped as to heat a heat-sensitive area of the mouth of the pouch until causing the opening thereof.

5. Device as claimed in claim 4, wherein the heating means comprise at least a nozzle (7) emitting a jet of warm air that heats the mouth of the pouch (1) until causing the detachment of the edges (3) of the mouth and the definition of an adequate cleft (6).

6. Device as claimed in claim 5, wherein the warm air is at a temperature of about 50° C.

7. Device as claimed in claim 4, wherein the heating means comprise a pair of heated shaped guides (4) between which transits the mouth area of the pouch (1) whilst the guides (4) press against the pouch itself or are simply in contact therewith.

8. Device as claimed in claim 7, wherein said shaped guides (4) have circular cross section and are therefore cylindrical bars.

9. Flexible pouch for food products, characterised in that it is opened by means of a method as claimed in claims 1 through 3 or by means of a device as claimed in claims 4 through 8.
